(19) United States
(12) Patent Application Publication
(10) Pub. No.: US 2005/0073619 A1
(43) Pub. Date: Apr. 7, 2005

(54) Multi-layered complementary wire structure and manufacturing method thereof

(76) Inventors: Yu-Cheng Chen, Hsintien City (TW); Chi-Lin Chen, Hsinchu City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/687,759

(22) Filed: Oct. 20, 2003

(30) Foreign Application Priority Data
Oct. 3, 2003 (TW) 92127501

(51) Int. Cl. G02F 1/136

(52) U.S. Cl. 349/43

(57) ABSTRACT

A multi-layered complementary wire structure and a manufacturing method thereof are disclosed, comprising a first wire and a second wire. Each of the first and the second wires comprises a main line and a plurality of branch lines located in a different layer from the main line. A plurality contact holes are formed in an insulating layer between the first wire and the second wire to connect the main line of the first wire and the branch lines of the first wire, and connect the main line of the second wire and the branch lines of the second wire. The main line of the first wire is insulated and crossed with the main line of the second wire. The main line of the first wire and the branch lines of the second wire are insulated with each other and located in the same layer. The main line of the second wire and the branch lines of the first wire are insulated with each other and located in the same layer.

### FIELD OF THE INVENTION

The present invention relates to a multi-layered complementary wire structure and a manufacturing method thereof, and more particularly, to a multi-layered complementary wire structure and a manufacturing method thereof that can substantially reduce the resistance of the wire.

### BACKGROUND OF THE INVENTION

With the rapid development of multimedia, user requirements for peripheral audio-visual equipment are raised accordingly. A conventional display composed of a cathode ray tube (CRT) or image tube is too large to satisfy the current demands for compact, lightweight equipment. Recently, many flat panel display technologies, such as liquid crystal display (LCD), plasma display panel (PDP) display and field emission display (FED), have been developed sequentially and have become the mainstream for future display.

FIG. 1 illustrates a schematic diagram of a thin film transistor array plate of a conventional display. Referring to FIG. 1, a thin film transistor array plate 10 comprises a plurality of pixel units, i.e. pixels 18, arranged in a matrix type. Each of the pixels 18 includes a thin film transistor 16, and the pixels 18 are separated by a plurality of gate lines 14 laterally parallelized and a plurality of data lines 12 vertically parallelized. The gate lines 14 and the data lines 12 are connected to the thin film transistors 16 of each of the pixels 18.

FIG. 2 illustrates a schematic diagram of a pixel of a conventional display. Referring to FIG. 2, each pixel 18 includes a thin film transistor 16. Each gate line 14 is connected to a gate 26 of the thin film transistor 16, and each data line 12 is connected to a source 20 and a drain 22 of the thin film transistor 16. An insulating layer (not shown) and an active layer 24 are located between the gate 26, the source 20 and the drain 22. Additionally, each pixel 18 further comprises a pixel electrode 28. The pixel electrode 28 is connected to the drain 22, and the thin film transistor 16 is used as a switch device of the pixel electrode 28.

In general, each gate line 14 and each data line 12 are located in different metal layers, and in the overlapping regions of the gate lines 14 and the data lines 12, the gate lines 14 are not connected to the data lines 12 and are insulated by insulated layers 30 peripherally, such as shown in FIG. 3. At present, displays are becoming larger and the lengths of the gate lines and the data lines are becoming longer, and thus the overall resistance is increasing to cause serious resistance capacitance delay (RC Delay), thereby limiting the design and manufacture of the device and affecting the operating speed of the device.

### SUMMARY OF THE INVENTION

An objective of the present invention is to provide a wire structure and a manufacturing method thereof, by using an at least two-layered wire structure to reduce the resistance of the wire, and using a complementary structure in the overlapping region of two wires to solve the problem of cross-intersected lines.

Another objective of the present invention is to provide a matrix structure of a display using a multi-layered complementary wire structure to constitute gate lines and data lines, so as to reduce the line dimension and increase the opening ratio of a pixel unit.

According to the aforementioned objectives of the present invention, the present invention provides a multi-layered complementary wire structure, comprising: at least a first wire, wherein the first wire comprises a main line, a plurality of branch lines and a plurality of plugs used to connect the main line and the branch lines; and at least a second wire, wherein the second wire comprises a main line, a plurality of branch lines and a plurality of plugs used to connect the main line and the branch lines. The main line of the first wire and the main line of the second wire are insulated and cross with each other. The main line of the first wire and the branch lines of the second wire are insulated with each other and located in the same layer, while the main line of the second wire and the branch lines of the first wire are insulated with each other and located in the same layer. The main line of the first wire and the main line of the second wire are in different layers.

According to the aforementioned objectives of the present invention, the present invention provides a method for manufacturing a multi-layered complementary wire structure, comprising: forming a first conductive material layer on a substrate; patterning the first conductive material layer to form a first main line and a plurality of first branch lines, , wherein the first main line is one part of a first wire, and the first branch lines are one part of a second wire, and the first main line is insulated from the first branch lines; then, forming a insulating layer on the first metal layer and the substrate, wherein the insulating layer comprises a plurality of first contact holes and a plurality of second contact holes, and the first contact holes expose portions of the first main line, and the second contact holes expose portions of each of the first branch lines; and subsequently forming a second conductive material layer to cover the insulating layer and fill the first contact holes and the second contact holes so as to form a plurality of first plugs in the first contact holes and a plurality of second plugs in the second contact holes; patterning the second conductive material layer to form a second main line and a plurality of second branch lines, and portions of the second main line are connected to the second plugs and portions of each of the second branch lines are connected to the first plugs, wherein the second main line is one part of the second wire, and the second branch lines are one part of the first wire, and the second main line is insulated from the second branch lines; then the multi-layered complementary wire structure is completed.

The first branch lines are located on two sides of the first main line respectively and in-line arranged, and the second branches lines are located on two sides of the second main line respectively and in-line arranged.

The first wire consists of the first main line, the first plugs, and the second branch lines. The second wire consists of the second main line, the second plugs, and the first branch lines.

With the application of a multi-layered complementary wire structure and a manufacturing method thereof of the present invention, the resistance of the overall wire can be reduced to increase the operating speed of the device, and the open ratio of the pixel unit can be increased as well.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a thin film transistor array plate of a conventional display.

FIG. 2 is a schematic diagram of a pixel of a conventional display.

FIG. 3 is a schematic diagram of a conventional metal layer structure where a gate line and a data line are located in different layers.

FIG. 4 illustrates a cross-sectional view of a wire structure of a gate line in accordance with a preferred embodiment of the present invention.

FIG. 5 illustrates a cross-sectional view of a wire structure of a data line matching the wire structure shown in FIG. 4.

FIG. 6 is a schematic, 3-D diagram showing the wire structure of FIG. 4 crossed with the wire structure of FIG. 5.

FIG. 7a to FIG. 8c are schematic flow diagrams showing the process for manufacturing a wire structure in accordance with a preferred embodiment of the present invention, in which FIG. 7a to FIG. 7c are cross-sectional diagrams taken along line I-I in FIG. 6, and FIG. 8a to FIG. 8c are cross-sectional diagrams taken along line II-II in FIG. 6.

FIG. 9 illustrates a top view of a wire structure according to the present invention applied in a display.

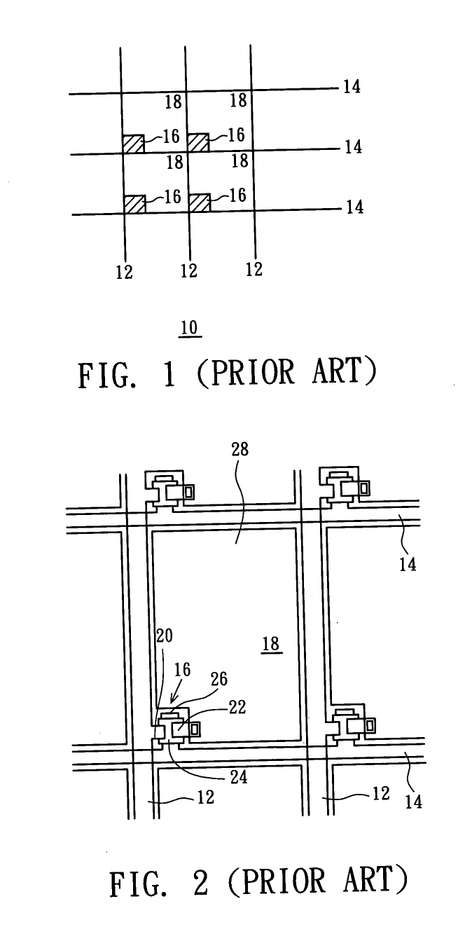

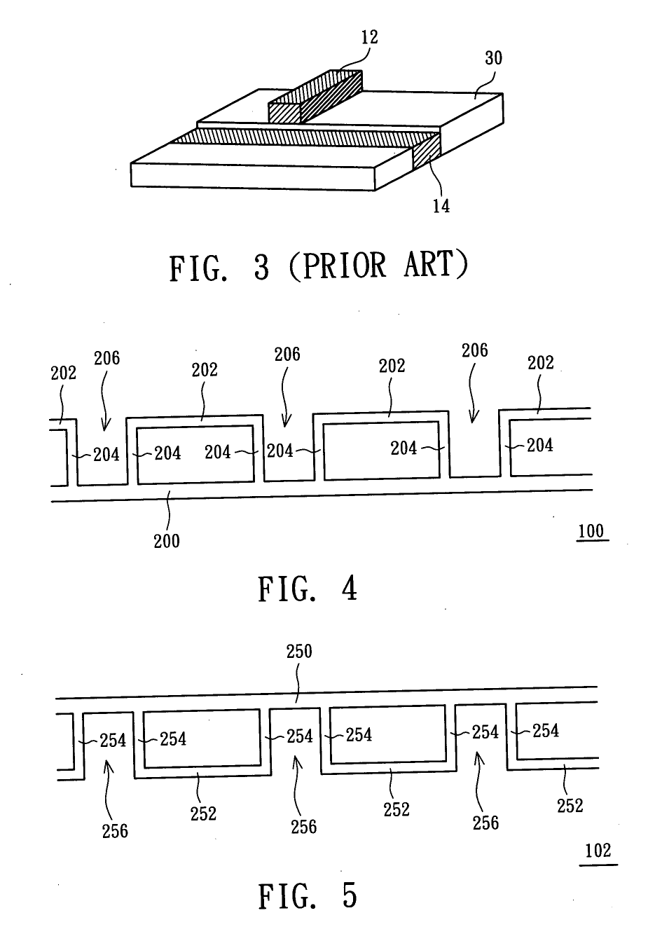

### DETAILED DESCRIPTION OF THE PREFERRED EMBODIMENT

The present invention discloses a wire structure having a multi-layered complementary feature. The following is an illustration in accordance with a preferred embodiment of the present invention. In order to make the illustration of the present invention more explicit and complete, the following description and the drawings from FIG. 4 to FIG. 9 are provided.

FIG. 4 illustrates a cross-sectional view of a wire structure of a gate line in accordance with a preferred embodiment of the present invention. Referring to FIG. 4, a wire structure 100 used as a gate line in a display of the present invention comprises a slender main line 200 and a plurality of branch lines 202 located in-line and separated. Because the main line 200 and the branch lines 202 are located in different layers, two ends of each of the branch lines 202 are connected to the main line 200 by plugs 204, thus forming a double-layered, toothlike wire structure comprising a plurality of fillisters 206.

A formula for calculating resistance is:
R=ρ*L/A,
where R represents the resistance of a material, ρ represents the resistivity of the material, L represents the length of a wire and A represents the cross-sectional area of the wire.

When using aluminum (Al) and copper (Cu) to manufacture conventional long wire structures respectively, and assuming a total length of the wires equal to 10 and the cross-sectional area of the wires equal to 1, the obtained resistances of the wire structures are listed as follows in Table 1:

TABLE 1

| | Material of wire | Resistance |
|---|---|---|
| Conventional wire structure | Al ρ = 2.67 | 26.7 μΩ |
| | Cu ρ = 1.67 | 16.7 μΩ |

In addition, taking the structure shown in FIG. 4 as an example, when using aluminum and copper to manufacture double-layered, toothlike wire structures of the present invention, assuming the main line 200 composed of one fillister 206, one branch line 202 and two plugs 204, the total length of the main line 200 equal to 10 the length of branch line 202 equal to b, the width of the fillister 206 equal to a (i.e. 10-b) and the cross-sectional areas of the main line 200 and the branch line 202 both equal to 1. When the ratio of the length of the branch line 202 to the width of the fillister 206 varies, the overall resistances are listed as follows in Table 2:

TABLE 2

| | | Resistance | | |
|---|---|---|---|---|
| | Material of wire | b/a = 9 | b/a = 6 | b/a = 2 |
| Double-layered, | Al ρ = 2.67 | 14.7 μΩ | 15.3 μΩ | 17.8 μΩ |
| toothlike wire | Cu ρ = 1.67 | 9.2 μΩ | 9.5 μΩ | 11.1 μΩ |
| structure | | | | |

Accordingly, no matter what the ratio of the length of the branch line 202 to the width of the fillister 206 is, the resistance of the double-layered, toothlike wire structure of the present invention is less than that of a conventional wire structure, so the present invention is not limited to the ratio of the length of the branch line 202 to the width of the fillister 206. In the double-layered, toothlike wire structure of the present invention, when the proportion of the branch line 202 parallel to the main line 200 increases, i.e. the ratio b/a increases, the resistance of the overall wire decreases.

When the wire structure of the gate line of the present invention is applied in a display, a wire structure used as a data line matching the gate line is illustrated in FIG. 5. Because the perpendicular-crossed connection between the gate line and the data line must be considered, the wire structure used as the data line is complementary to the wire structure used as the gate line. Referring to FIG. 5, a wire structure 102 comprises a long main line 250 and a plurality of branch lines 252 located in-line and separated. Two ends of each of the branch lines 252 are connected to the main line 250 by plugs 254, thus forming a double-layered, toothlike wire structure comprising a plurality of fillisters 256. Comparing the structure in FIG. 5 with that in FIG. 4, it can be seen that the wire structure 100 in FIG. 4 and the wire structure 102 in FIG. 5 are symmetrical.

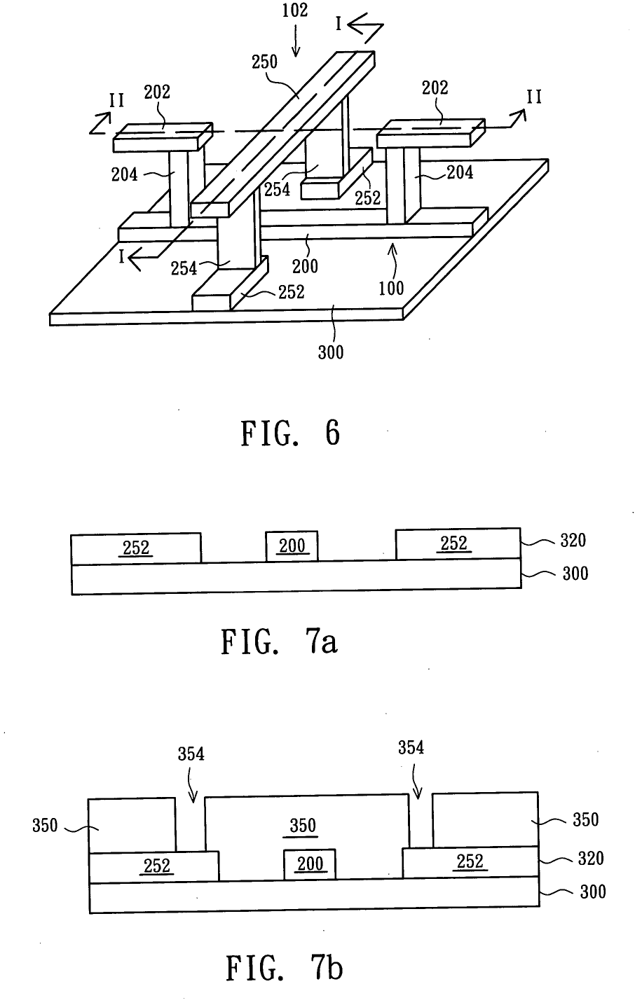

FIG. 6 is a schematic, 3-D diagram showing the wire structure shown in FIG. 4 crossed with the wire structure shown in FIG. 5. Referring to FIG. 6, in a typical display, gate lines and data lines are mutually perpendicular to form a crossed structure, and thus constructing pixel units arranged in a matrix. In the present invention, the wire structure 100 used as the gate line and the wire structure 102 used as the data line are arranged by crossing so that the fillisters 206 in FIG. 4 and the fillisters 256 in FIG. 5 are opposite each other on a substrate 300. That is to say, the main line 200 of the wire structure 100 and the branch lines 252 are in the same layer, and the branch lines 252 are located on two sides of the main line 200, respectively. The main line 250 of the wire structure 102 and the branch lines 202 are all in another layer.

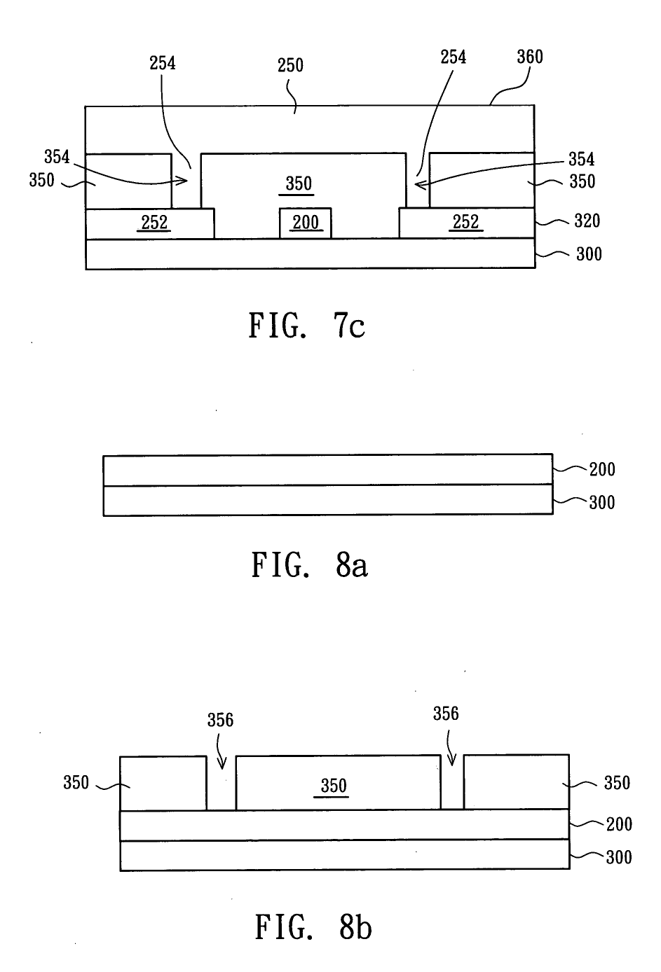

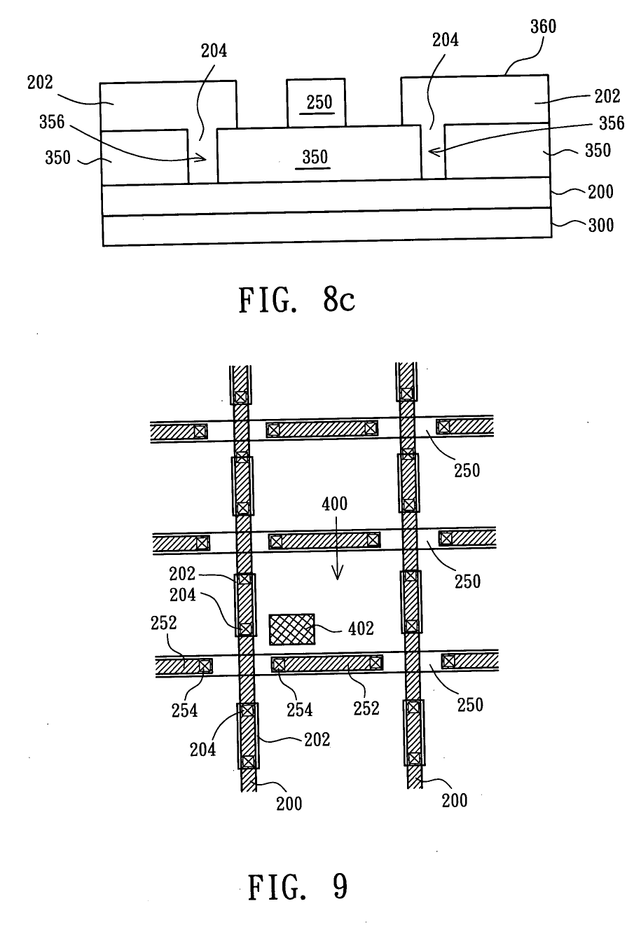

Referring to FIG. 7a to FIG. 8c, FIG. 7a to FIG. 8c are schematic flow diagrams showing the process for manufacturing a wire structure in accordance with a preferred embodiment of the present invention. With simultaneous reference to FIG. 6, FIG. 7a to FIG. 7c are cross-sectional diagrams taken along line I-I in FIG. 6, and FIG. 8a to FIG. 8c are cross-sectional diagrams taken along line II-II in FIG. 6.

When forming a wire structure of the present invention, a conductive material layer 320 is first formed on a substrate 300 by, for example, a deposition method. The conductive material layer 320 is defined by, for example, photolithography and etching to form a main line 200 of the wire structure 100 and branch lines 252 of the wire structure 102, as illustrated in FIG. 7a and FIG. 8a.

Then, an insulating layer 350 is formed to cover the conductive material layer 320 and the substrate 300 by, for example, a deposition method. Next, the insulating layer 350 is defined by, for example, photolithography and etching to form a plurality of contact holes 354 and a plurality of contact holes 356 in the insulating layer 350, as illustrated in FIG. 7b and FIG. 8b. Each of the contact holes 354 exposes a portion of the branch lines 252 of the wire structure 102, respectively, and the contact holes 356 expose a portion of the main line 200 of the wire structure 100.

Subsequently, a conductive material layer 360 is formed to cover the insulating layer 350 and fill the contact holes 354 and the contact holes 356 by, for example, a deposition method. A plurality of plugs 254 and a plurality of plugs 204 are formed respectively with the conductive materials in the contact holes 354 and the contact holes 356. Next, the conductive material layer 360 is defined by, for example, photolithography and etching to form a main line 250 of the wire structure 102 and branch lines 202 of the wire structure 100, as illustrated in FIG. 7c and FIG. 8c.

Hence, a double-layered complementary wire structure such as the one illustrated in FIG. 6 is formed on the substrate 300. The plugs 204 and the plugs 254 all must align with the main line 200 of the wire structure 100 and the branch lines 252 of the wire structure 102, and are separated from one another. Further, in addition to align with the plugs 204, the branch lines 202 of the wire structure 100 also need to align with the main line 200 of the wire structure 100, and in addition to align with the plugs 254, the main line 250 of the wire structure 102 also must align with the branch lines 252 of the wire structure 102.

FIG. 9 illustrates a top view of a wire structure applied in a display in the present invention. Referring to FIG. 9, from the top view, a plurality of main lines 200 that is lower and is vertically parallelized and a plurality of main lines 250 that is higher and is horizontally parallelized are clearly illustrated. From the top view, the main lines 200 and the main lines 250 are crossed perpendicularly to form a reticulate structure, in which each grid of the reticulate structure represents a pixel unit 400, and each pixel unit 400 comprises a thin film transistor 402. Except for a cross-interconnected portion of the main lines 200 and the main lines 250, the rest of the reticulate structure is a double-layered wire structure.

For example, excluding the cross-interconnected portion, each of the main lines 200 comprises a plurality of branch lines 202 (located in the same layer as the main lines 250) which is above the main lines 200, and the main lines 200 are connected to the branch lines 202 by the plugs 204. Similarly, excluding the cross-interconnected portion, each of the main lines 250 comprises a plurality of branch lines 252 (located in the same layer as the main lines 200) which is above the main lines 250, and the main lines 250 are connected to the branch lines 252 by the plugs 254.

In FIG. 9, it is worthy of note that the width of the main lines 250 and the width of the branch lines 202 in the upper wire structure broader than that of the main lines 200 and that of the branch lines 252 in the lower wire structure merely for a better understanding of the objective of the wire structure of the present invention. In the preferred embodiment of the present invention, the aforementioned wires comprising the main lines 250, the branch lines 202, the main lines 200 and the branch lines 252 preferably have the same width, but the foregoing description is intended to illustrate and not limit the scope of the invention.

Although the preferred embodiment of the present invention only discloses a double-layered complementary wire structure and the manufacturing method thereof, the spirit and the concept of the present invention also can be applied in other multi-layered wire structures having more than two layers to obtain the objective of reduced resistance.

The present invention discloses a multi-layered complementary wire structure and the manufacturing method thereof. The structural conditions comprising, for example, the material of the insulated layer, and the material, shape and length of the wire can be changed according to the requirements of product devices. Aluminum, chromium, and molybdenum are typically used as the material of the wire. Further, many kinds of thin film transistor structures are applied in pixel units, and the kind of the thin film transistor structure used in the present invention is not limited.

According to the aforementioned preferred embodiment of the present invention, with the application of the present invention, the resistance of the wire can be reduced. In addition, for the same effect of resistance, the application of the multi-layered complementary wire structure can decrease the cross-sectional area of the wire, thus increasing the opening ratio of the pixel unit. In the preferred embodiment of the present invention, by using a double-layered complementary wire structure with a wire width of 12 μm, the present invention can obtain the same resistance as the conventional wire structure with a wire width of 20 μm. For an opening area with a length of 60 μm and a width of 140 μm, the original opening area is:
60×140=8400(μm²).

But, with the application of the present invention, the opening area is:
(60+8)×(140+8)=10064(μm²).

So, the increase of the opening ratio is:
(10064−8400)/8400×100%=19.8%.

Accordingly, the present invention is greatly advantageous for display manufacturing technology.

The multi-layered complementary wire structure of the present invention can be applied not only in the display field, but also in the other fields. When the multi-layered complementary wire structure of the present invention is applied in the other fields, the wire structure 100 illustrated in FIG. 6 and the wire structure 102 are not limited to use as a gate line or a data line. When the present invention is applied in the other fields, such as, for example, integrated circuit manufacturing technology, advantages of reducing resistance and decreasing critical dimension can be obtained. Therefore, the present invention is not limited to the display field.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

1. A multi-layered complementary wire structure, comprising:
at least a first wire, comprising:
a first main line;
a plurality of first branch lines; and
a plurality of contact holes used to connect the first main line and the first branch lines; and
at least a second wire, comprising:
a second main line;
a plurality of second branch lines; and
a plurality of contact holes used to connect the second main line and the second branch lines,
wherein, the first main line is insulated and crossed with the second main line, the first main line is insulated from the second branch lines, the first main line and the second branch lines are located in a first conductive material layer, the second main line is insulated from the first branch lines, and the second main line and the first branch lines are located in a second conductive material layer.

2. The multi-layered complementary wire structure according to claim 1, wherein the first main line is perpendicularly crossed with the second main line.

3. The multi-layered complementary wire structure according to claim 1, wherein each of the first branch lines is connected to the first main line by two of the first contact holes.

4. The multi-layered complementary wire structure according to claim 1, wherein each of the second branch lines is connected to the second main line by two of the second contact holes.

5. A matrix structure of a display, comprising:
a substrate;
a plurality of pixel units arranged in a matrix and located on the substrate, wherein the pixel units are separated by a plurality of gate lines vertically parallelized and separated, and a plurality of data lines laterally parallelized and separated, wherein:
each of the gate lines comprises:
a first main line;
a plurality of first branch lines parallel to the first main line; and
a plurality of first contact holes mutually parallel, wherein the first contact holes are used to connect to the first main line and the first branch lines; and
each of the data lines comprises:
a second main line;
a plurality of second branch lines parallel to the second main line; and
a plurality of second contact holes mutually parallel, wherein the second contact holes are used to connect to the second main line and the second branch lines;
wherein, the first main line is insulated and crossed with the second main line, the first main line is insulated from the second branch lines, the first main line and the second branch lines are located in a first conductive material layer, the second main line is insulated from the first branch lines, and the second main line and the first branch lines are located in a second conductive material layer.

6. The matrix structure of the display according to claim 5, wherein each of the pixel units comprises a thin film transistor structure.

7. The matrix structure of the display according to claim 5, wherein the gate lines are perpendicularly crossed with the data lines.

8. The matrix structure of the display according to claim 5, wherein each of the first branch lines is connected to the first main line by two of the first contact holes.

9. The matrix structure of the display according to claim 5, wherein each of the second branch lines is connected to the second main line by two of the second contact holes.

10. A method for manufacturing a multi-layered complementary wire structure, comprising:
forming a first conductive material layer on a substrate;
patterning the first conductive material layer to form at least a first main line and a plurality of first branch lines, wherein the first branch lines are respectively located on two sides of the first main line and in-line arranged, and the first main line is insulated from the first branch lines, the first main line is a first part of a first wire, and the first branch lines are a first part of a second wire;
forming a insulating layer on the first conductive material layer and the substrate;
patterning the insulating layer to form a plurality of first contact holes and a plurality of second contact holes, and the first contact holes expose a portion of the first main line, and the second contact holes expose a portion of each of the first branch lines;
forming a second conductive material layer to cover the insulating layer and fill the first contact holes and the second contact holes ; and
patterning the second conductive material layer to form at least a second main line and a plurality of second branch lines, wherein the second branch lines are in-line arranged and respectively located on two sides of the second main line, and the second main line is insulated from the second branch lines, the second main line is a second part of the second wire and the second branch lines are a second part of the first wire, and the second main line is located above the first branch lines and the second branch lines are located above the first main line.

11. The method for manufacturing the multi-layered complementary wire structure according to claim 10, wherein the first main line is perpendicularly crossed with the second main line.
